(19) United States
(12) Patent Application Publication
(10) Pub. No.: US 2004/0066407 A1
(43) Pub. Date: Apr. 8, 2004

(54) Intelligent windows movement and resizing

(75) Inventors: Tim Regan, Sammamish, WA (US); Brian Meyers, Bellevue, WA (US); Greg Smith, Bellevue, WA (US); Mary Czerwinski, Woodinville, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/600,399

(22) Filed: Jun. 20, 2003

Related U.S. Application Data
(60) Provisional application No. 60/417,085, filed on Oct. 8, 2002.

(51) Int. Cl. G09G 5/00

(52) U.S. Cl. 345/764

(57) ABSTRACT

Snapping graphical components relative to other graphical components in a display is disclosed. Collinear lines for each of the edges of a first graphical component are automatically determined. The collinear lines extend the edges of the display. When an edge of a second graphical component is moved to within a predetermined distance of one of the collinear lines, the edge of the second graphical component snaps to the collinear line. Snapping of the edge of the second graphical component to the collinear line of the first graphical component either repositions the second graphical component or resizes the second graphical.

### CROSS-REFERENCE TO RELATED APPLICATION

Pursuant to 35 U.S.C. § 119, this application claims the benefit of the filing date of provisional application No. 60/417,085, filed Oct. 8, 2002, entitled “Intelligent Windows Movement and Resize,” the subject matter of which application is incorporated herein by reference.

### FIELD OF THE INVENTION

The present invention relates in general to graphical component movement in computer user interfaces, and in particular, to a system and method of snapping graphical components into positions relative to other graphical components across display regions or displays.

### BACKGROUND OF THE INVENTION

In recent years, worldwide use of computers has increased dramatically. Computer application programs (“applications”, “programs,” or “apps”) are used for a variety of purposes including word processing, accounting, database management, desktop publishing, communications, and the like. The efficiency of computer utilization is improved by allowing a user to easily access a variety of different programs directed to accomplishing tasks and fulfilling the various goals of the user. For example, an accountant might make regular and extensive use of a word processing program, an e-mail program, a spreadsheet program, and a personal information manager, each of which is represented as a program window on the computer display. Rather than having all these programs present on the same part of the screen, the accountant may arrange the program windows around the display or across multiple displays. Moving program windows across multiple monitors or around large screens and consistent arrangement of these windows may often become tiresome due to the relatively large display distances involved.

Some operating systems allow users to customize program window display locations and to keep a program window at a particular location across multiple monitors. Such customization allows users to arrange their program windows, but does not help them with the dynamic arrangement and alignment of windows when various programs need to be moved around a “display region.” A display region is the portion of a computer display that contains program windows. Unfortunately, many users lack the patience and/or tools to efficiently arrange and align program windows using the currently available options provided by operating systems. As a result, users tend to use program windows less efficiently, thereby making programs, in particular, more commonly used programs, more time consuming and difficult to access.

Therefore, a need exists for a new and improved method for assisting users in dynamically arranging and aligning program windows in a computing display environment in a way that improves the accessibility of program windows.

### SUMMARY OF THE INVENTION

The present invention is directed to a method, user interface, system, and computer-readable medium for positioning graphical components in computer displays. In accordance with one aspect of the present invention, a method of positioning graphical components by depicting a graphical component, e.g., graphical component A, that snaps into a location relative to another graphical component, e.g., graphical component B, is provided. Horizontal and vertical lines defined by the top, bottom, left, and right edges of graphical component B are automatically determined. The lines, which form a rectangular around the graphical component, are extended to form collinear lines. These collinear lines are used to control the snapping of one graphical component into a position relative to another graphical component. More specifically, when an edge of graphical component A moves within a predetermined distance of one of the collinear lines determined by graphical component B's edges, component A's edge snaps to the collinear line. Snapping the edge of component A to the collinear line of component B may either reposition component A or extend component A to the collinear line that component A's edge snapped to.

In accordance with a further aspect of the present invention, an indication is received to automatically resize For example, graphical component A may be automatically resized when an edge of component A is moved until it meets (snaps to) a line collinear to one of component B's edges.

In accordance with other aspects of the present invention, the predetermined distance from a collinear line is either uniform across all collinear lines or is gradated. Gradated distance is useful when the predetermined distance varies over the distance from the component where the lines originate, varies across display regions, or varies based on predefined relationships between graphical components (e.g., if certain graphical components are related due to content and/or component groupings).

As can be seen from the summary above, the present invention provides a method and user interface for effectively positioning graphical components in computing displays and display regions as well as a related computer-readable medium and system.

### BRIEF DESCRIPTION OF THE DRAWINGS

The foregoing aspects and many of the advantages of this invention will become more readily appreciated as the same become better understood by reference to the following detailed description, when taken in conjunction with the accompanying drawings, wherein:

FIG. 1 is a block diagram of a personal computer that provides an exemplary operating environment for an embodiment of the present invention;

FIG. 2 is a flow diagram illustrating a routine for window snap processing in accordance with the present invention; and

FIGS. 3-5 are exemplary screen shots of operating system user interfaces formed by embodiments of the present invention.

### DETAILED DESCRIPTION OF THE PREFERRED EMBODIMENT

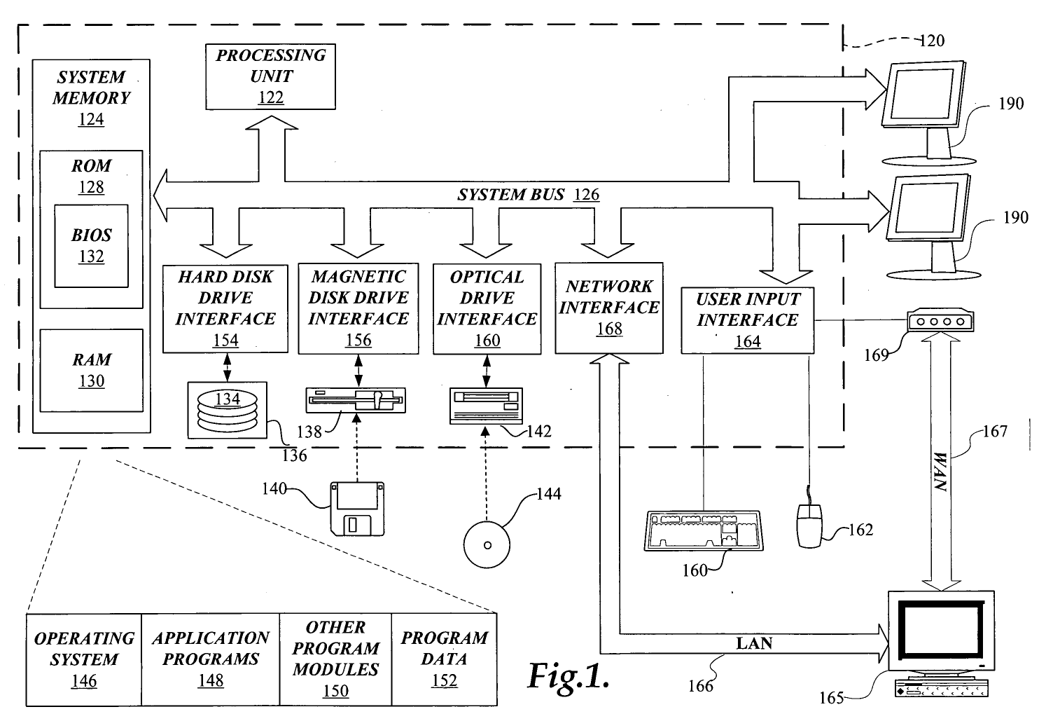

The detailed description which follows is represented largely in terms of processes and symbolic representations of operations by conventional computer components, including a processor, memory storage devices for the processor, connected display devices, and input devices. These processes and operations may utilize conventional computer components in a heterogeneous distributed computing environment, including remote file servers, computer servers, and memory storage devices. Each of these conventional distributed computing components is accessible by the processor via a communication network. FIG. 1 illustrates an example of a suitable computing system environment in which the invention may be implemented. The computing system environment shown in FIG. 1 is only one example of a suitable computing environment and is not intended to suggest any limitation as to the scope of use or functionality of the invention. Neither should the computing environment be interpreted as having any dependency requirement relating to any one or a combination of components illustrated in the exemplary operating environment.

The invention is operational in numerous general purpose or special computing system environments or configurations. Examples of well known computing systems, environments, and/or configurations that may be suitable for implementing the invention, include, but are not limited to, personal computers, server computers, laptop devices, multiprocessor systems, microprocessor-based systems, network PC's, mini-computers, mainframe computers, and distributed computing environments that include any of the above systems, or the like.

The invention may be described in the general context of computer-executable instructions, such as program modules, being executed by a computer. Generally, program modules include routines, programs, objects, components, data structures, etc. that perform a particular task or implement particular abstract data types.

With reference to FIG. 1, an exemplary system for implementing the invention includes a general purpose computing device in the form of a computer 120. Components of the computer 120 include, but are not limited to, a processing unit 122, a system memory 124, one or more displays 190, and a system bus 126 that couples various system components including the system memory 124 to the processor 122. The system bus 126 may be any of several types of bus structures including a memory bus or memory controller, peripheral bus, or a local bus using any of a variety of bus architectures. By way of example, and not limitation, such architectures include industry standard architecture (“ISA”) bus, microchannel architecture (“MCA”) bus, enhanced ISA (“EISA”) bus, video electronic standards association (“VESA”) local bus, peripheral component interconnect (“PCI”) bus, also known as mezzanine bus, and accelerated graphics port (“AGP”) bus.

The computer 120 typically includes a variety of computer-readable media. Computer-readable media can be any available media that can be accessed by the computer 120 and include both volatile and non-volatile media, and removable and non-removable media.

By way of example, and not limitation, computer-readable media may comprise computer storage media and communication media. Computer storage media includes, but is not limited to, RAM, ROM, EEPROM, flash memory or other memory technology, CD-ROM, digital versatile disc (“DVD”) or other optical storage, magnetic cassettes, magnetic tape, magnetic disk storage or other magnetic storage devices, or any other medium that can be used to store or communicate the desired information and that can be accessed by the computer 120.

The communication media typically embodies computer-readable instructions, data structures, program modules, or other data in a modulated data signal, such as a carrier wave or other typical transport mechanism, and includes any information delivery media. The term “modulated data signal” means a signal that has one or more of its characteristics set or changed in such a manner to encode information in the signal. By way of example, and not limitation, communication media includes wired media, such as a wired network or direct wired connection, and wireless media, such as acoustic, radio frequency, infrared, and other wireless media. Combinations of any of the above should also be included within the scope of computer-readable media.

The system memory 124 includes computer storage media in the form of volatile and non-volatile memory, such as read only memory (“ROM”) 128 and random access memory (“RAM”) 130. A basic input/output system 132 (“BIOS”) containing basic routines that help to transfer information between elements within the computer 120, such as during startup, is typically stored in ROM 128. RAM 130 typically contains data and/or program modules that are immediately accessible to, and/or presently being operated on, by the processing unit 122. By way of example, and not limitation, FIG. 1 illustrates an operating system 146, application programs 148, other program modules 150, and program data 152.

The computer 120 may also include removable/non-removable, volatile/non-volatile computer storage media. By way of example only, FIG. 1 illustrates a hard disk drive 134 that reads from or writes to non-removable, non-volatile magnetic media 136, a magnetic drive 138 that reads from or writes to a removable, non-volatile magnetic disk 140, and an optical drive 142 that reads from or writes to a removable, non-volatile optical disc 144, such as a CD-ROM or other optical media. Other removable/non-removable, volatile/non-volatile computer storage media that can be used in the exemplary operating environment include, but are not limited to, magnetic tape cassettes, flash memory cards, DVD's, digital video tapes, Bernoulli cap cartridges, solid state RAM, solid state ROM, and the like. The hard disk drive 134, magnetic disk drive 138, and optical disc drive 142 may be connected to the system bus 126 by a hard disk drive interface 154, a magnetic disk drive interface 156, and an optical drive interface 158, respectively. Alternatively, hard disk drive 134, magnetic disk drive 138, and optical disc drive 142 may be connected to the system bus 126 by a small computer system interface (“SCSI”).

The drives and their associated computer storage media discussed above and illustrated in FIG. 1, provide storage of computer-readable instructions, data structures, program modules, and other data from the computer 120. In FIG. 1, for example, the hard disk drive 134 may also store the operating system 146, application programs 148, other programs 150 and program data 152. Note that these components can either be the same as or different from the operating system 146, the other program modules 150, and the program data 152. A user may enter commands and information into the computer 120 through an input device, such as keyboard 160 and/or a pointing device 162, commonly referred to as a mouse, trackball, or touch pad. Other input devices (not shown) may include a microphone, a joystick, a game pad, a satellite dish, a scanner, or the like. These and other input devices are often connected to the system bus 126 through user input interface 164 and may be connected by other interface and bus structures, such as a parallel port, serial port, game port, universal serial bus (“USB”), or other interface.

The computer 120 may operate in a network environment using logical connections to one or more remote computers 165. The remote computer 165 may be a personal computer, a server, a router, a network PC, a peer device, or other common network node and typically includes many or all the elements described above relative to the computer 120. The logical connections depicted in FIG. 1 include a local area network (“LAN”) 166 and a wide area network (“WAN”) 167, but may also include other networks. Such network environments are commonplace in offices, enterprise-wide computer networks, intranets, and the Internet.

When used in a LAN environment, the computer 120 is connected to the LAN 166 through a network interface 168. When using a WAN environment, the computer typically includes a modem or other means for establishing communication over the WAN, including a network interface 168, over the WAN 167, such as the Internet. The modem 169, which may be internal or external, may be connected to the system bus 126 via the user input interface 164 or other appropriate mechanism. It will be appreciated that the network connections shown are exemplary and that other means of establishing communications between computers may be used. Although many other internal components of the computer 120 are not shown, those of ordinary skill in the art will appreciate that such components and their interconnections are well known. Accordingly, additional details concerning the internal construction of the computer 120 need not be disclosed in connection with the present invention.

Those skilled in the art will understand that program modules, such as the operating system 146, the application programs 148, and the data 152 are provided to the computer 120 via one of its memory storage devices, which may include ROM 128, RAM 130, hard disk 134, magnetic disk drive 138, or optical disc drive 142. The hard disk drive 134 is used to store data 152 and programs, including the operating system 146 and application programs 148.

When the computer 120 is turned on or reset, the BIOS 132, which is stored in ROM, instructs the processing unit 122 to load the operating system 146 from the hard disk drive 134 into the RAM 130. Once the operating system 146 is located into RAM 130, the processing unit 122 executes the operating system code and causes the visual elements associated with the user interface of the operating system to be displayed on a monitor. When an application program 148 is opened by a user, the program code and relevant data are read from the hard disk drive 134 and stored in RAM 130.

The present invention provides a system, method, and computer readable medium for snapping program windows within a graphical user interface (“GUI”) based upon predetermined criteria.

In an exemplary embodiment of the present invention, windows are arranged such that they “snap” to each other or to each other's collinear lines. Collinear lines are lines that extend outwardly from horizontal and vertical lines defined by a rectangular window or that extend outwardly from two horizontal and vertical lines of a rectangle defined by the edges of a graphical component. Collinear lines are determined by locating the defining horizontal and vertical lines and extending them to the edge of a display region. Other windows snap to the collinear lines. Snapping allows users to align a number of windows with their tops or side all along a single collinear line. Snapping is particularly helpful with computers having multiple displays (or display regions) because it is not always easy to align windows across multiple displays due to different viewing angles and distances.

It will also be appreciated by those of ordinary skill in the art and others that collinear lines may be other than vertical or horizontal line, in particular when non-rectangular graphical components have non-vertical and/or non-horizontal edges. Accordingly in an alternate embodiment of the present invention, collinear line associated with the edge of graphical components may be at an incline to the vertical or horizontal axis.

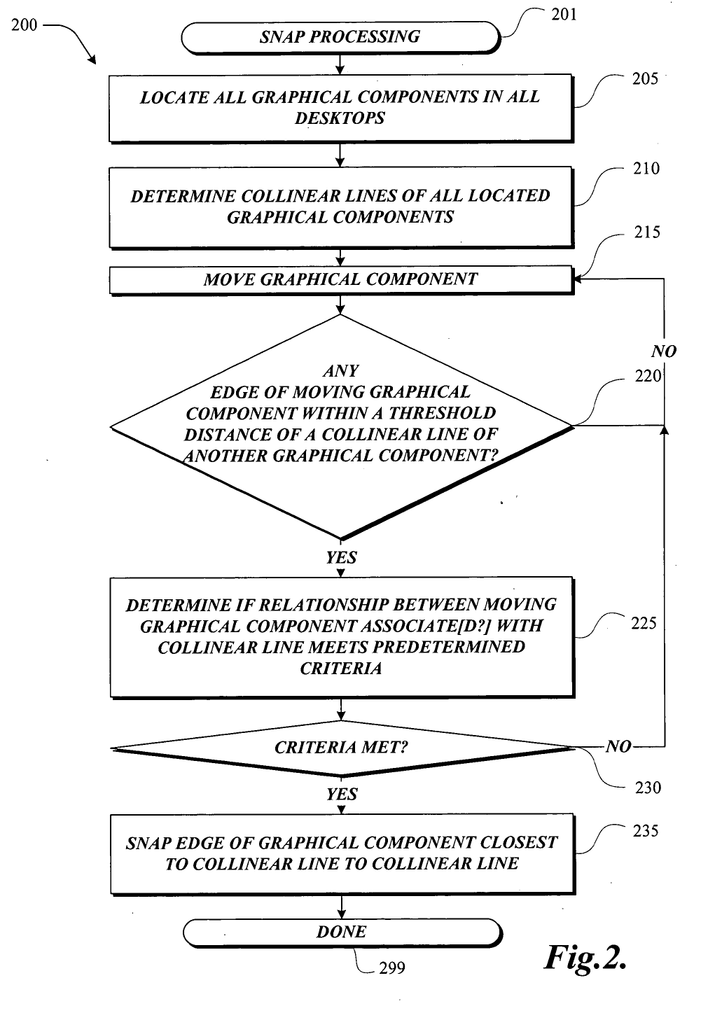

FIG. 2 illustrates a snap processing routine 200 suitable for assisting users to position graphical components (windows, tool bars, task bars, icons, etc.) within a display region with respect to the edges of the display region and/or other graphical components. Routine 200 begins at block 201 and proceeds to block 205 where all graphical components in all display regions (e.g., desktops) are located. Next, in block 210 the collinear lines of all of the located graphical components are determined.

At this point, routine 200 has all the data it needs to snap process graphic component movement when a user begins to move a graphical component using, for example, a mouse (block 215). A determination is made (decision block 220) whether any edge of the moved graphical component is within a threshold distance of a collinear line of one of the located graphical components. If not, routine 200 cycles back to block 215 and continues to monitor the movement of the graphical component. This loop continues until decision block 220 determines that the graphical component is within a threshold distance of a collinear line of a graphical component. This determination can be made by comparing the coordinates of pixels of the moving graphical component and a “snap region” lying on either side of the collinear line, for example. Processing then proceeds to block 225 where a test is made to determine if the relationship to the graphical object of the collinear line meets certain predetermined criteria. Such criteria might include, but are not limited to, being within a certain distance to the moved graphical component, being within the same suite of applications as the moved graphical component, being associated with the same application as the moved graphical component, or other criteria for logically grouping application windows. For example if the criteria is the closeness of the moving graphical component to the graphical component associated with the collinear line in the other coordinate direction; then if the moving graphical component is approaching a horizontal collinear line near one vertical edge of a display region and the graphical component associated with the horizontal collinear line is located at the other vertical edge of the display region, the two graphical components may be sufficiently far enough apart to make snapping to the horizontal collinear line undesirable.

Next, in decision block 230 a determination is made whether the criteria were met. If so, then, in block 235 the edge of the moved graphical component, that is closest to the collinear line is snapped to the collinear line. This may be presented to a user as a visual snapping and/or as a force feedback response to a graphical component manipulation device, such as a mouse 162 or other input device (e.g., keyboard, trackball, motion detector, stylus, etc.) used by a user. Routine 200 then ends at block 299. If, however, in decision block 230 it is determined that the criteria is not met, processing loops back to block 215 where the movement of the graphical component is monitored. No snapping occurs until the requirements of decision blocks 220 and 230 are met.

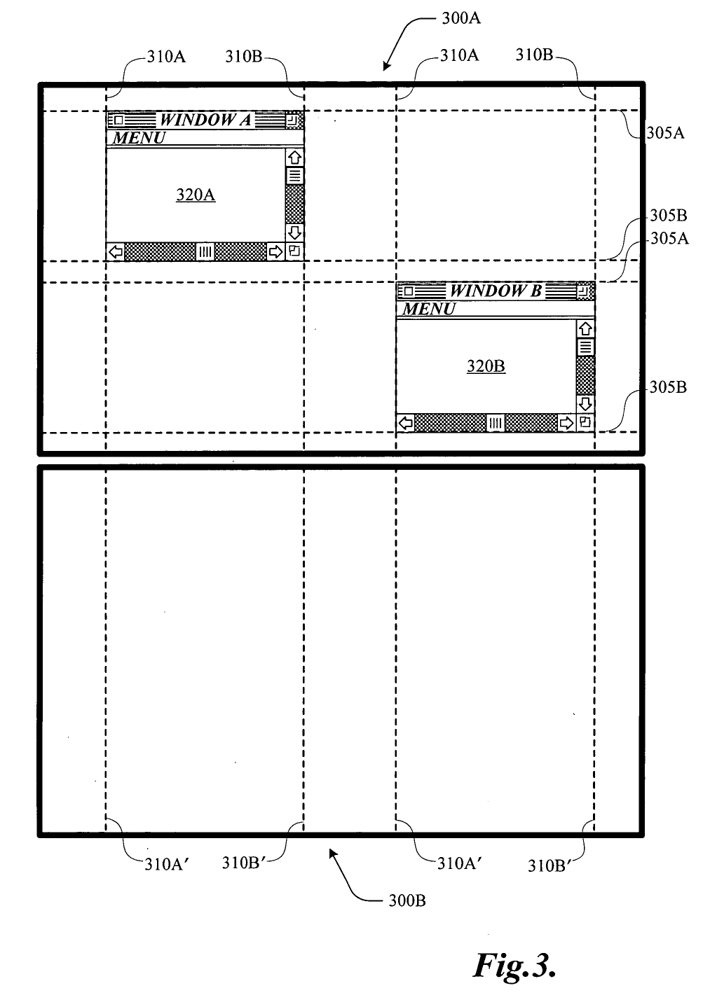

FIG. 3 illustrates an exemplary vertical arrangement of two display regions 300A, 300B (possibly on separate displays 190) for displaying program windows (or other graphical components) in accordance with the present invention. One of the display regions 300B includes two program windows 320A and 320B. FIG. 3 also illustrates the collinear lines associated with the two graphical components illustrated as program windows 320A and 320B used to determine snapping described above in connection with the snap processing routine 200. Specifically, each program window 320A and 320B includes two vertical collinear lines 310A and 310B and two horizontal collinear lines 305A, 305B. Because display region 300A is located above display region 300B, the vertical collinear lines 310A and 310B in display region 300A are shown as vertical collinear lines 310A′, 310B′ in the lower display region 300B. Those of ordinary skill in the art and others will appreciate that if the display regions 300A, 300B had been horizontally arranged, the horizontal collinear lines 305A, 305B would have extended across both display regions.

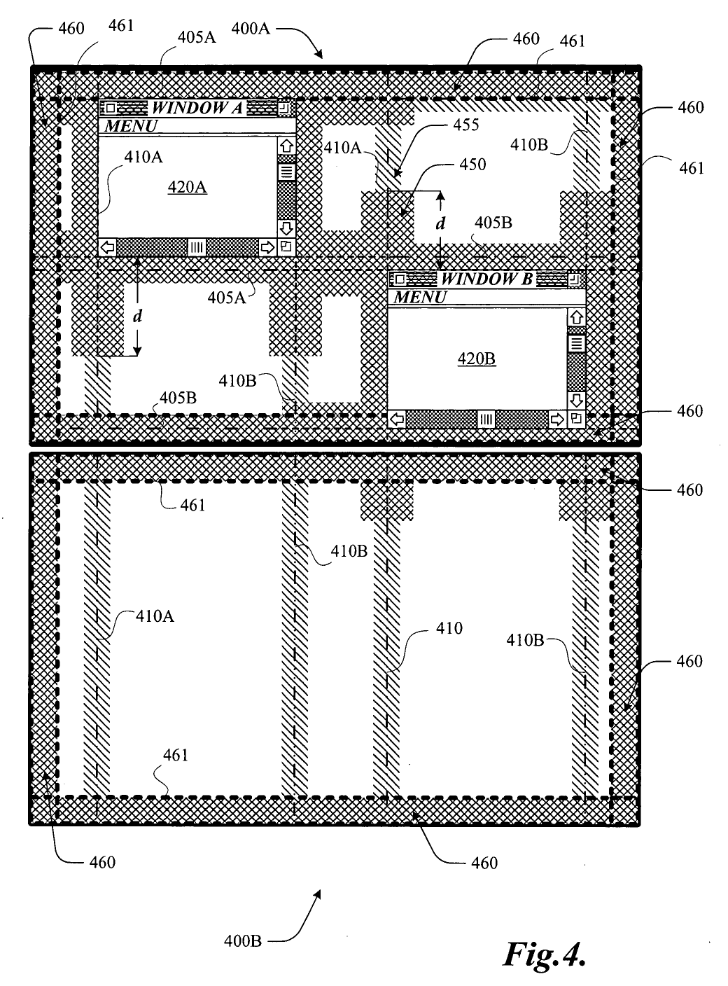

FIG. 4 is similar to FIG. 3, but illustrates other aspects of the present invention. More specifically, two display regions 400A, 400B are vertically arranged that are similar to the two display regions shown in FIG. 3. FIG. 4 includes the “snap regions” 450, 455 that lie different predetermined distances from the collinear lines 405A, 405B and 410A, 410B of program windows 420A, 420B. The two snap regions 450, 455 have different gradations. Snap region 450 is a proximate snap region and snap region 455 is a distal snap region. The distance (d) the proximal snap region extends from its associated graphical component and where the distal snap region begins lies a predetermined distance from a graphical component, e.g., program windows 420A, 420B. More specifically, the distance (d) along a vertical collinear line 410A or 410B is from the edge of a program windows 420A, 420B and extend out to the distance (d) along a collinear line as shown in FIG. 4. Distal snap region 450 is further away from the graphical component 420B whose edge the collinear line 410A or 410B is collinear with. Accordingly, in this exemplary embodiment, program windows or other graphical components must be moved closer to a collinear line in a distal snap region 455 than in a proximal snap region 450 before snapping occurs. Those skilled in the art and others will appreciate that more than two gradations of the predetermined distances may be used without departing from the spirit and scope of the present invention. FIG. 4 also illustrates that the display regions 400A, 400B can be graphical components with inner edge snap regions 460, i.e., snap regions surrounding the inner edges of the display regions defined by lines 461 located a predetermined distance inward from the edges of the display region. Accordingly, it will be apparent to those of ordinary skill in the art and others that a graphical component can snap both to a collinear line associated with another graphical component or the edge of a display region.

Snapped graphical components can slide along the collinear line in one orthogonal direction that the graphical component is snapped to and snap to another collinear line in the other orthogonal direction. For example, starting from the center of display region 400A, the graphical component 420A could first be moved upwardly until it snaps to the top of display region 400A. Then the graphical component 420A could be slid to the left until it snaps to the left side of display region 400A, ending in the upper left corner of the display region.

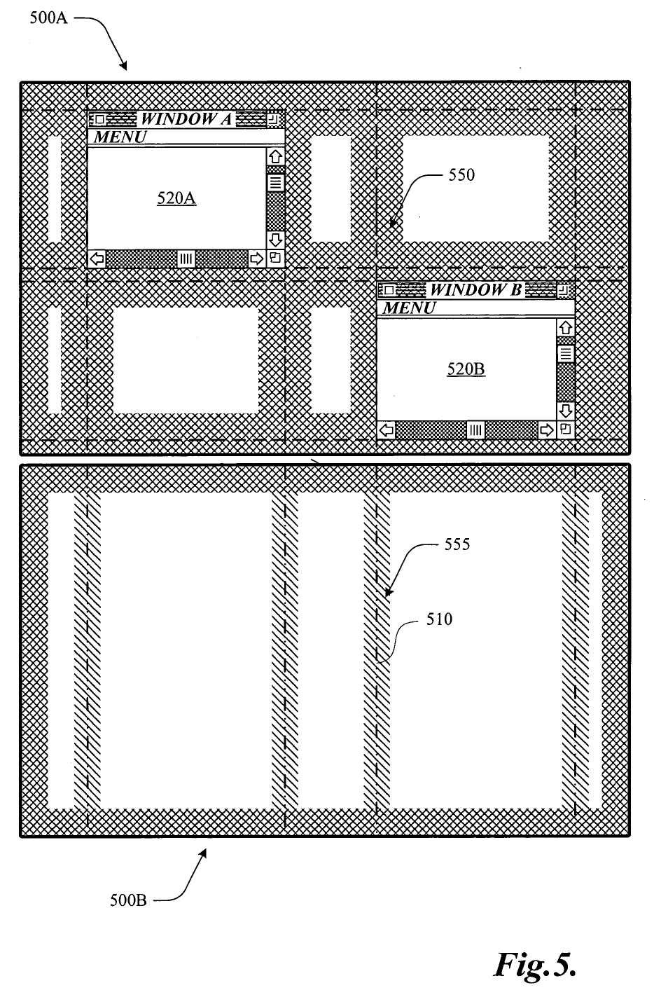

FIG. 5 illustrates yet another embodiment of the present invention wherein the gradation between proximate snap regions 550 and distal snap regions 555 is determined not by the distance from a graphical component, but rather the display region 500A and 500B in which the graphical components 520A and 520B are located. In FIG. 5, the proximal snap regions 550 are in one display region 500A and the distal snap regions 555 are in another display region 500B.

As shown in FIGS. 3-5, snap regions may overlap. In overlapping snap regions, the snap processing routine 200, described above, causes a moving graphical component to snap to the collinear line associated with the first snap region entered. If desired, in overlapping regions between collinear lines the decision regarding which line to snap to can be made proportional to the width of the snap region associated with each collinear line. For example, if one collinear line has a snap region width of 30 pixels and the other collinear line has a snap region width of 15 pixels, and the lines are 30 pixels apart, the 30-pixel collinear line would snap a graphical component coming within 20 pixels and the 15-pixel collinear line would snap a graphical component coming within 10 pixels.

Those of ordinary skill in the art and others will appreciate that the user interfaces illustrated in FIGS. 3-5 and described above are merely examples and that many more user interfaces may be implemented without departing from the spirit and scope of the present invention. For example, many more gradations of snap regions may be implemented, including smooth transition gradations determined according to some form of linear, geometric, or exponential decay based on distance.

While illustrated embodiments of the invention have been illustrated and described, it will be appreciated that various changes can be made therein without departing from the spirit and scope of the invention as defined by the appended claims.

The embodiments of the invention in which an exclusive property or privilege is claimed are defined as follows:

1. A computer implemented method of positioning a graphical component in a display, the method comprising:
determining collinear lines for a first graphical component;
detecting the movement of an edge of a second graphical component;
determining when said edge of the second graphical component is moved within a predetermined distance of one of said collinear lines of said first graphical component; and
automatically aligning said edge of said second graphical component with said one of said collinear lines of said first graphical component.

2. The method of claim 1, wherein said first graphical component is a polygonal component.

3. The method of claim 1, wherein said first graphical component has a shape selected from the group consisting of triangle, quadrilateral, pentagon, hexagon, septagon, octagon, nonagon, and decagon shapes.

4. The method of claim 1, wherein automatically moving said edge of said second graphical component comprises moving said first display component.

5. The method of claim 1, wherein said second graphical component is resized.

6. The method of claim 5, further comprising receiving an indication to resize said first display component until said edge of said first display component is within said predetermined distance of one of said lines collinear to an edge of said second display component.

7. The method of claim 1, wherein said predetermined distance is uniform along said collinear line.

8. The method of claim 1, wherein said predetermined distance is gradated along said collinear line.

9. The method of claim 8, wherein said gradated predetermined distance varies according to the proximity of said first graphical component to said second graphical component.

10. The method of claim 9, wherein said proximity is measured in pixels.

11. The method of claim 9, wherein said proximity is measured in display regions.

12. The method of claim 1, wherein said predetermined distance varies according to a predefined relationship between said first graphical component and said second graphical component.

13. The method of claim 12, wherein said predetermined relationship is determined from the type of graphical components forming said first and second graphical components.

14. The method of claim 12, wherein said predetermined relationship is determined from the contents of said first and said second graphical components.

15. The method of claim 1, further comprising receiving an indication to reposition said first display component until said edge of said first display is within said predetermined distance of one of said lines collinear to an edge of said second display component.

16. A computer readable media containing computer executable instructions for performing the method of any of claims 1-15.

17. A computer apparatus having a processor and a memory storing computer executable instructions operative to perform the method of any of claims 1-15.

18. A graphical user interface of a computer with relative snapping positioning of windows, the graphical user interface comprising:
a first window in a computer display;
a second window in said computer display;
automatically determined lines collinear to edges of said second window; and
automatically moving an edge of said first window to one of said automatically determined lines when said edge of said first window is within a predetermined distance of said one of said automatically determined lines.

19. The graphical user interface of claim 18, wherein automatically moving said edge of said first display component comprises moving said first window.

20. The graphical user interface of claim 18, wherein automatically moving said edge of said first display component comprises resizing said first window.
